(19) United States
(12) Patent Application Publication
(10) Pub. No.: US 2006/0231121 A1
(43) Pub. Date: Oct. 19, 2006

(54) Low pressure injection module and method for low pressure injection cleaning with residual dirt analysis of components

(76) Inventors: Konrad Koeberle, Backnang (DE); Anke Mueller, Besigheim (DE)

Correspondence Address: KENYON & KENYON LLP, ONE BROADWAY, NEW YORK, NY, 10004, US

(21) Appl. No.: 10/550,052

(22) PCT Filed: Mar. 24, 2004
(86) PCT No.: PCT/DE04/00603

§ 371 Date: Mar. 20, 2006

(30) Foreign Application Priority Data
Apr. 11, 2003 (DE) 103 16 644.0

(51) Int. Cl. B08B 7/04; B08B 3/00

(52) U.S. Cl. 134/10; 134/18; 134/21; 134/110; 134/113; 134/186; 134/198

(57) ABSTRACT

A method for low-pressure spray cleaning and residual contaminant analysis of components includes providing a receiver tank filled with flushing medium, pressurizing the receiver tank with compressed air on the inlet side, transmitting the pressurized flushing medium to a spray lance, spray cleaning a component by spraying the flushing medium from the spray lance, collecting the particle-containing flushing medium after the spray cleaning in a collection tank, providing an inline analysis filter positioned on an outflow side of the collection tank in such a way that particle-containing flushing medium flows through it, filtering the particles out of the flushing medium using the analysis filter, and finally analyzing the residual contamination filtered out by the analysis filter. A low-pressure spray module suitable for use with this method is also provided.

### FIELD OF THE INVENTION

The present invention relates to a method for low-pressure spray cleaning and residual contaminant analysis of components using a low-pressure spray module.

### BACKGROUND INFORMATION

At the present time, residual cleaning and residual contaminant determination of components is performed using the dipping method including ultrasonic testing, if necessary. Using such a method, it is possible to ensure that the outer surfaces of components are cleaned. In contrast, cleaning of internal areas of components, e.g., through holes or blind holes, is not ensured in every case. In some cases, wash stands are also used for cleaning, in which a cleaning medium is pumped through the component in a closed circuit at high pressures using adapters.

Accordingly, the described methods for residual cleaning and residual contaminant determination of components have the disadvantages that in many cases, it is not possible, or is very difficult, to clean through holes and blind holes; the cleaning modules used are usually only adapted to specific component geometries; and the cleaning modules frequently require a costly filtering method due to the closed circuit of the flushing medium.

Therefore, an object of the present invention is to avoid the above-described disadvantages and provide a method for low-pressure spray cleaning and residual contaminant analysis, as well as a low-pressure spray module, such that controlled internal cleaning of even poorly accessible areas, such as through holes and blind holes, is feasible using simple filter technology, and which method is compatible with various component geometries.

### SUMMARY

A low-pressure spray module provides a particle-free pressurization which is carried out without a pump, using a receiver tank which contains a flushing medium pressurized with compressed air. Ab exchangeable spray lance having a variable diameter, shape and length is attached on the outlet side of the receiver tank, it being possible to couple the spray lance to a metering diaphragm valve; if nozzles are used, external cleaning of the components is also possible, and furthermore, the particle-containing flushing medium arising during the spray cleaning is collected in a collection tank in which an analysis filter is installed, which filters the particles out of the flushing medium and preserves them for later analysis.

A method for low-pressure spray cleaning and residual contaminant analysis of components, using the above-described low-pressure spray module, includes the following steps:
A: providing a receiver tank filled with a flushing medium;
B: pressurizing the receiver tank on the inlet side using compressed air from a compressed air source;
C: guiding the pressurized flushing medium from the receiver tank to a spray lance;
D: spray cleaning the component by spraying the flushing medium from the spray lance;
E: collecting the particle-containing flushing medium in a collection tank after the spray cleaning;
F: providing an analysis filter positioned on an outflow side of the collection tank in such a way that the particle-containing flushing medium flows through it;
G: filtering the particles out of the flushing medium using the analysis filter, and
H: analyzing the residual contamination filtered out by the analysis filter.

In one example, filtering out of the particles by suction of the flushing medium is supported using a vacuum pump situated at the outflow side of the collection tank downstream of the analysis filter. The residual contaminant analysis of the particles filtered out may be performed by optical microscopy or scanning electron microscopy. These features provide the following advantages of the method and the low-pressure spray module according to the present invention:
controlled internal cleaning of poorly accessible areas in components, such as through holes or blind holes, by using exchangeable spray lances having matched geometry;
variable pressure (e.g., 2 bar to 6 bar) settable or adjustable depending on the component;
no costly filter technology due to open flushing circuit;
filter produced specifically for cleanliness analysis to be performed using a scanning electron microscope or optical microscope;
usable for various component geometries; and
dead-volume-free, low particle system technology.

### BRIEF DESCRIPTION OF THE DRAWING

FIG. 1 shows a block diagram for illustrating an exemplary embodiment of the method of the present invention for low-pressure spray cleaning and residual contaminant analysis, as well as a low-pressure spray module used for it.

### DETAILED DESCRIPTION

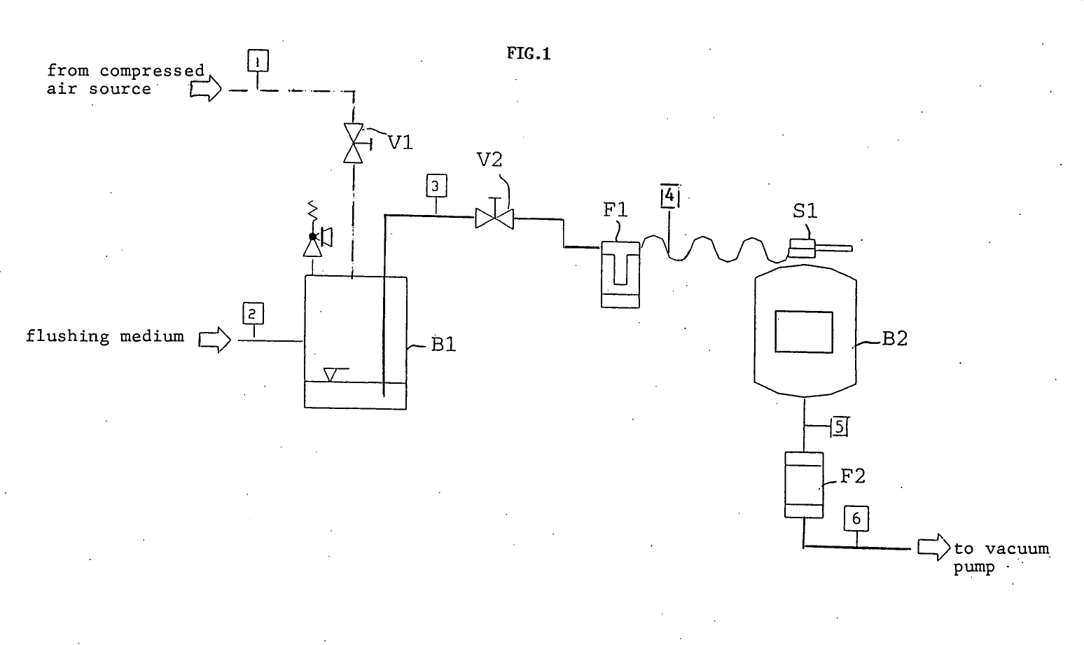

As shown in FIG. 1, a low-pressure spray module is used according to the present invention, the main components of which include: a receiver tank B1 which is pressurized using compressed air from a compressed air source (line 1), the receiver tank being filled with a flushing medium (via a line 2), a spray lance S1 (also interchangeably called spray unit or flushing lance) connected to the outlet side of receiver tank B1 via a prefilter F1 and being in flushing medium communication with receiver tank B1 via the flushing medium, a collection tank B2, an inline analysis filter F2 which is connected to collection tank B2 via a line 5 and which filters out particles from the particle-containing flushing medium from collection tank B2 after the component is washed and preserves them for later analysis, and a vacuum pump (not shown) connected via a line 6. All system parts may be made of stainless steel and are dead-volume-optimized.

Receiver tank B1 is first filled with a filtered flushing medium via line 2. The tank may be operated by connecting it to a compressed air system (line 1) as a compressed air source at a maximum pressure of approximately 6 bar. The tank pressure is controlled or regulated by a valve V1 located in compressed air line 1. The flushing medium may also be supplied to long through holes via spray unit S1 having a lance. To ensure the necessary movability of flushing lance S1, flushing lance S1 is connected to prefilter F1 via a flexible hose 4. A second regulating/setting valve V2 is located in line 3 between prefilter F1 and receiver tank B1 for a requirements-based regulation/setting of the pressure and/or the volume of the flushing medium to prefilter F1 or to flushing lance S1. The exchangeability of spray lance S1, the diameter and length of which may vary depending on the component, and flexible line 4 make it possible to flush, i.e., spray out, components of complex design, i.e., including through holes and blind holes produced in the component from different sides.

The particle-containing flushing medium is collected in receiver tank B2 after the components are sprayed out. To that end, the upper opening of collection tank B2 advantageously widens toward the top in the shape of a funnel. The particle-containing medium collected in collection tank B2 is drawn off via inline analysis filter F2 using the vacuum pump (not shown). Immediately afterwards, it is possible to examine the filter and analyze it for the determination of residual contamination.

An undesired alternative avoided by the present invention would be to generate the pressure for the flushing medium via pumps, which would necessitate a costly filter technology for the flushing medium in order to ensure that it would have high purity. Furthermore, a high pressure drop arises, which must be accounted for in the pump power output. In contrast, an open circuit is used in the method of the present invention, in which the pressure is variable in a simple manner and no costly filter technology is needed.

The method described for low-pressure spray cleaning and residual contaminant analysis of components, and the low-pressure spray module used for such method, may be used on components having purity-critical internal areas, for example, high pressure pumps for diesel injection systems, injection nozzles, hydraulic power units for ABS systems, and other components of motor vehicle injection systems.

1-12. (canceled)

13. A low-pressure spray module for spray cleaning a component, comprising:
a receiver tank for holding a flushing medium, wherein an inlet side of the receiver tank is pressurized using compressed air from a compressed air source;
a spray lance for pressurized spraying of the component using the flushing medium, wherein the spray lance is connected to an outlet side of the receiver tank;
a collection tank positioned for collecting contaminant-particles-containing flushing medium after the pressurized spraying of the component; and
an analysis filter coupled to an outflow side of the collection tank, wherein the contaminant-particles-containing flushing medium is extracted from the collection tank through the outflow side using a vacuum pump, whereby the analysis filter performs filtering of contaminant particles from the contaminant-particles-containing flushing medium, and wherein the analysis filter collects the contaminant particles for later analysis.

14. The low-pressure spray module as recited in claim 13, wherein the spray lance is interchangeably attached to the receiver tank.

15. The low-pressure spray module as recited in claim 13, wherein a compressed air supply line leading from the compressed air source to the receiver tank transmits the compressed air, wherein the compressed air supply line has a first valve for at least one of regulating and setting of the pressure of the compressed air.

16. The low-pressure spray module as recited in claim 14, wherein a compressed air supply line leading from the compressed air source to the receiver tank transmits the compressed air, wherein the compressed air supply line has a first valve for at least one of regulating and setting of the pressure of the compressed air.

17. The low-pressure spray module as recited in claim 15, further comprising:
a pre-filter for the flushing medium, wherein the pre-filter is positioned between the receiver tank and the spray lance.

18. The low-pressure spray module as recited in claim 17, further comprising:
a second valve for at least one of regulating and setting one of the pressure and the volume of the flushing medium transmitted to the spray lance, wherein the second valve is positioned between the pre-filter and the receiver tank.

19. The low-pressure spray module as recited in claim 13, wherein the spray lance is connected to a metering valve.

20. A method for low-pressure spray cleaning and residual contaminant analysis of a component, comprising:
a) providing a receiver tank filled with a flushing medium;
b) pressurizing the receiver tank on an inlet side using compressed air from a compressed air source;
c) transmitting the flushing medium from the pressurized receiver tank to a spray lance;
d) spray cleaning the component by spraying the flushing medium from the spray lance;
e) collecting contaminant-particles-containing flushing medium in a collection tank after the spray cleaning;
f) providing an analysis filter positioned on an outflow side of the collection tank, whereby the contaminant-particles-containing flushing medium flows through the analysis filter, wherein contaminant particles are filtered out of the contaminant-particles-containing flushing medium by the analysis filter; and
g) analyzing the contaminant particles filtered out by the analysis filter.

21. The method as recited in claim 20, wherein the pressure of the compressed air in step b) is one of regulated and set to a selected value.

22. The method as recited in claim 21, wherein the flushing medium transmitted to the spray lance in step c) is pre-filtered through a pre-filter.

23. The method as recited in claim 22, wherein the spray lance used in step d) is configured to be exchangeable as a function of the component geometry.

24. The method as recited in claim 20, wherein for step f), a vacuum pump situated downstream of the analysis filter on the outflow side of the collection tank is provided to aid the contaminant-particles-containing flushing medium to flow through the analysis filter.

25. The method as recited in claim 20, wherein the analyzing in step g) is performed by one of optical microscopy and scanning-electron microscopy.
